(19) United States
(12) Patent Application Publication
(10) Pub. No.: US 2006/0050734 A1
(43) Pub. Date: Mar. 9, 2006

(54) System and method for network capacity enhancements using a variable vocoder

(75) Inventor: Nagi A. Mansour, Arlington, VA (US)

Correspondence Address: CROWELL & MORING LLP;INTELLECTUAL PROPERTY GROUP, P.O. BOX 14300, WASHINGTON, DC, 20044-4300, US

(73) Assignee: NEXTEL COMMUNICATIONS, INC., Reston, VA (US)

(21) Appl. No.: 11/194,167

(22) Filed: Aug. 1, 2005

Related U.S. Application Data
(60) Provisional application No. 60/608,128, filed on Sep. 9, 2004.

(51) Int. Cl. H04L 12/26; H04J 3/16; H04Q 7/00; H04J 3/14; H04J 1/16; H04J 3/22; H04L 1/00

(52) U.S. Cl. 370/468; 370/229; 370/472

(57) ABSTRACT

A system and method for assigning a vocoder mode to a voice communication of a telephone call is disclosed. In an embodiment of a method, the method includes determining a utilization factor for a telecommunications network and assigning a vocoder mode to the voice communication dependent upon the utilization factor. In an embodiment of a system, the system includes a variable vocoder with a first mode and a second mode. The first mode provides a voice quality for a voice communication which is better than a voice quality provided by the second mode. If a utilization factor of the network is not indicative of a peak utilization, the first mode is assigned to the voice communication and if the utilization factor is indicative of the peak utilization, the second mode is assigned to the voice communication.

This application claims the benefit of U.S. Provisional Patent Application Ser. No. 60/608,128, filed Sep. 9, 2004, the disclosure of which is herein expressly incorporated by reference.

### FIELD OF THE INVENTION

The present invention relates generally to the field of telecommunications, and in particular, to increasing network capacity through the use of a variable voice encoder/decoder (vocoder).

### BACKGROUND OF THE INVENTION

In providing cellular telephone services, telecommunications providers are generally interested in providing the highest quality of service while still maximizing the capacity of the network. Sometimes these are competing objectives. With respect to network capacity, cellular network operators desire to maximize network system capacity. Higher network capacity results in less rejections of call requests and, in-turn, increased customer satisfaction. Therefore, it is desirable to increase network capacity.

In providing the highest quality of service, high rate vocoders have been utilized to provide good voice quality for cellular calls. As is known, a vocoder converts the spoken words of the caller into a digital signal and then reconverts the signal into an audible sound so that the words can be heard by the intended recipient. These high rate vocoders provide good voice quality however, in general, these high coding/decoding rates utilize more network capacity than lower rate vocoders.

Variable vocoders have also been used. One such type of variable vocoder that has been developed is the Selectable Mode Vocoder (SMV). This type of variable vocoder is a variable-rate vocoder. The SMV selects an optimal encoding rate based on input speech characteristics. The SMV technique is based on the premise that different portions of conversations can be encoded at different rates For example, it may be more desirable to use the vocoder's higher rates to encode complex speech patterns, e.g., long vowel sounds, and use the lower rates to encode periods of silence. In this manner, the data rates are chosen based on the input speech. With the SMV vocoder, there are four modes of operation, each offering a different percentage of frames at different coding rates.

Another type of variable vocoder is the Adaptive Multi-rate Vocoder (AMR). The AMR is not a variable-rate vocoder, such as the SMV, but rather, operates at one of eight available data rates. The AMR slowly switches between fixed encoding rates based on RF channel conditions.

Currently, variable vocoders try to obtain the highest quality voice based on some factor associated with the voice communication. For example, as discussed above, the SMV vocoder chooses a coding rate based on the input speech characteristics. The AMR vocoder chooses from among several fixed encoding rates based on RF channel conditions. Therefore, currently, variable vocoders are utilized to obtain the highest possible voice quality for any particular voice communication. Whereas this may result in some network efficiencies, variable vocoders provide other opportunities for increasing network capacity that have not yet been realized in the prior art. Therefore, it is desirable to provide a new system and method for utilizing the capabilities of variable vocoders for increasing network capacity.

### SUMMARY OF THE INVENTION

A system and method for assigning a vocoder mode to a voice communication of a telephone call is provided. In an embodiment of a method of the present invention, the method includes determining a utilization factor for a telecommunications network that transports the voice communication of the telephone call and assigning a vocoder mode to the voice communication dependent upon the utilization factor.

In an embodiment of a system of the present invention, the system includes a variable vocoder wherein the vocoder includes a first mode and a second mode and wherein the first mode provides a voice quality for a voice communication which is better than a voice quality provided by the second mode. If a utilization factor of the network is not indicative of a peak utilization the first mode is assigned to the voice communication and if the utilization factor is indicative of the peak utilization the second mode is assigned to the voice communication.

### BRIEF DESCRIPTION OF THE DRAWINGS

FIG. 1 illustrates an embodiment of a system in accordance with the principles of the present invention.

FIG. 2 illustrates an embodiment of a method in accordance with the principles of the present invention.

FIG. 3 illustrates a second embodiment of a method in accordance with the principles of the present invention.

### DETAILED DESCRIPTION OF THE EXEMPLARY EMBODIMENTS

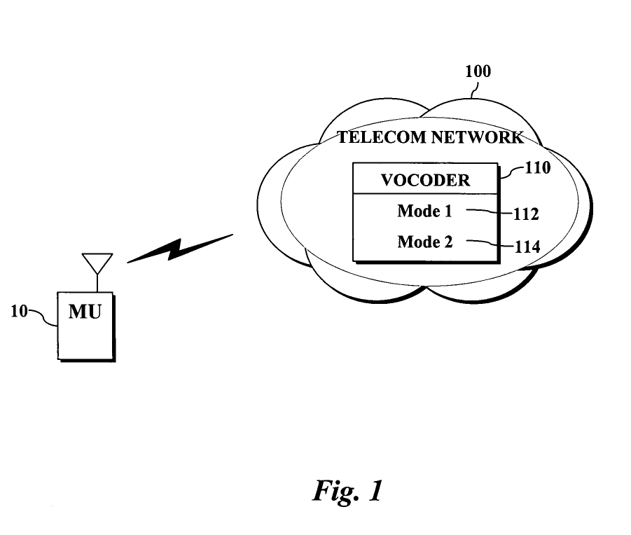

FIG. 1 illustrates an embodiment for a system of the present invention. As can be seen, the system includes a telecommunications network 100 and a voice encoder/decoder (vocoder) 110. Vocoder 110 is a variable vocoder as it includes a plurality of modes, each with a coding/decoding rate(s), that can be used to transform analog voice into a digital data stream and vice versa. As can be seen, vocoder 110 is illustrated as including two modes, i.e., mode 1 as identified by reference numeral 112 and mode 2 by reference numeral 114. However, the present invention is not limited to the vocoder only including two modes. Any number of modes, with associated coding rates, can be practiced in the present invention.

As is known, when a caller makes a telephone call through telecommunications network 100 by using mobile unit 10, the vocoder 110 in network 100 encodes and decodes the voice communication. The vocoder 110 uses one or more rates to encode/decode the communication.

In accordance with exemplary embodiments of the present invention, variable vocoder 110 may be either a variable-rate vocoder, such as the Selectable Mode Vocoder (SMV), or a multi-rate vocoder, such as the Adaptive Multi-rate Vocoder (AMR).

As discussed previously, the SMV vocoder communicates at one of four rates: 9600 bits per second (bps), 4800 bps, 2400 bps, and 1200 bps. As is known, SMV was designed to provide an optimal representation of speech in various background noise environments. It utilizes an algorithm to continually choose optimal encoding rates based on input speech characteristics. This ensures that the sound quality of the voice communication is optimal by using a rate, as selected by the algorithm, based on the input speech characteristics. There are four modes of operation for SMV, which are selectable by an operator. Each mode provides a different percentage of frames at different code rates.

The AMR vocoder, unlike the SMV, is not a variable-rate vocoder but rather operates at one of eight available data rates. As discussed, the AMR slowly switches between fixed encoding rates based on RF channel conditions.

Whereas the present invention can be practiced with either a variable-rate vocoder or a multi-rate vocoder, such as those discussed above, the present invention is not limited to only these types of variable vocoders, and is particularly not limited to only the SMV and AMR vocoders. The present invention can be practiced with any vocoder that provides a plurality of modes, with each mode including a unique rate or combination of rates.

In accordance with the principles of the present invention, network capacity can be increased by selectively using the modes of the variable vocoder based on busy/peak and non-busy/off-peak hours of the network. Currently, vocoders are utilized to provide the highest possible voice quality for a voice communication based on a condition or set of conditions that directly relate to the voice communication itself, e.g., background noise, speech patterns, RF channel conditions, etc. However, higher vocoder rates utilize more network capacity. With the present invention, a less-than-optimal vocoder rate is utilized when lesser voice quality is acceptable and when increased network capacity is desirable. The present invention recognizes that a lesser voice quality for the communication is acceptable under certain conditions, and that by use of the variable vocoder at a lesser rate than what is optimal for a set of conditions, network capacity can be reserved while still providing an acceptable voice quality. Thus, a determination as to whether to use a less-than-optimal vocoder rate, or optimal rate, is based on factors independent of the voice communication itself, e.g., time of day or utilization rate of the network.

In further describing the present invention, as discussed previously, vocoder 110 has at least two modes, i.e., mode 1 and mode 2, where the voice quality provided by mode 1 is higher than mode 2. Consequently, the use of mode 1 (with it's higher coding rate) will require greater network resources than mode 2, and thus, will result in less capacity in network 100 for supporting other requirements. In accordance with exemplary embodiments of the present invention, mode 1's higher rate and better voice quality is used for off-peak hours of network utilization and mode 2's lesser rate and lesser voice quality is used for the peak hours. Thus, by using lesser rate mode 2 during peak hours of network utilization, less network resources are required by the vocoder, and therefore, more network capacity is available during this peak utilization period for other requirements. The utilization of the lesser vocoder rate at peak utilization periods of the network can result in approximately 20% more network capacity. During non-peak network periods, when network capacity is not as great of a concern, higher rate mode 1 is utilized. Thus, the highest quality voice is provided during non-peak periods.

Whereas use of the lesser vocoder rate of mode 2 at peak network utilization periods will provide reduced voice quality, this reduced quality is generally acceptable during these peak periods. These peak periods normally occur during times of the day when the callers are most busy, and thus, less likely to be engaged in long social conversations where quality of the voice is more important. Rather, during these busy periods of the day, the information in the voice communication is more important to the callers than the voice quality of the communication. For example, during these busy periods, callers usually engage in short conversations such as “Is dinner ready?” and “Do you need me to bring anything?” Therefore, at these busy hours of the day, and corresponding peak periods of network utilization, people are usually interested in short informational conversations where lesser voice quality is adequate. In these circumstances, lesser rate mode 2 is utilized which provides acceptable voice quality while conserving network capacity. During non-busy hours, and corresponding off-peak periods of network utilization, Mode 1 is utilized to provide the highest voice quality. This highest quality is generally desirable when callers are engaged in social conversations during the more leisurely times of the day.

Assigning vocoder modes for certain periods of the day, e.g., based on either the time of day or network utilization rate, can be done by the telecommunications network. For example, as shown in the table below, the telecommunications network could assign lesser rate mode 2 for peak hours 7-9 AM and 4-7 PM and higher rate mode 1 for the off-peak hours. The time of day can be applied geographically by the network based on local time for each different geographic area, and associated time zone, serviced by the network. The table also illustrates the relative effect of the mode choice on voice quality and the remaining available network capacity.

| Vocoder Mode | Voice Quality | Capacity | Time of Day |
|---|---|---|---|
| Mode 1 | Higher | Moderate | Off-Peak hours |
| Mode 2 | Moderate | Higher | Peak hours |
| | | | (7-9 AM) & (4-7 PM) |

In the present invention, determining or designating the “peak” and “off-peak” utilization period(s) of the network for using an appropriate rate mode(s) is not limited to determining or designating particular hours of the day. The present invention is not limited to how peak utilization periods are determined or designated. For example, as illustrated above, peak periods may be determined and designated by particular periods of the day which historically have been associated with high network utilization periods. Alternatively, peak periods could be determined and designated by calculating network capacity utilization rates. All that is required is that a peak utilization period(s) of the network be determined and that a vocoder rate that is less than optimal for the conditions associated with the voice communication, e.g., background noise, RF channel conditions, etc., is utilized during the peak utilization period(s) of the telecommunications network, regardless of how the period(s) is determined or designated.

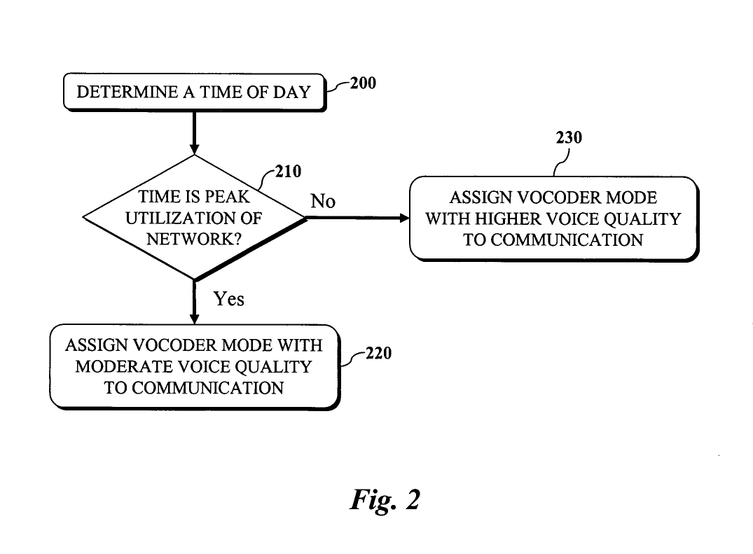

Further to the above description, FIG. 2 illustrates an embodiment of a method of the present invention. As can be seen, in step 200, the time of day is determined by the network. In step 210, the network determines whether the time is associated with a peak utilization of the network. If the time of day is associated with a peak utilization period of the network, in step 220 a vocoder mode with moderate voice quality is used. If the time of day is not associated with a peak utilization period, in step 230 a vocoder mode with higher voice quality is used. In determining whether the time of day is associated with a peak utilization period of the network, the present invention is not limited to any particular methodology. For example, the network can use a look-up table to see if the time is within a defined peak utilization time period, e.g., 7-9 AM.

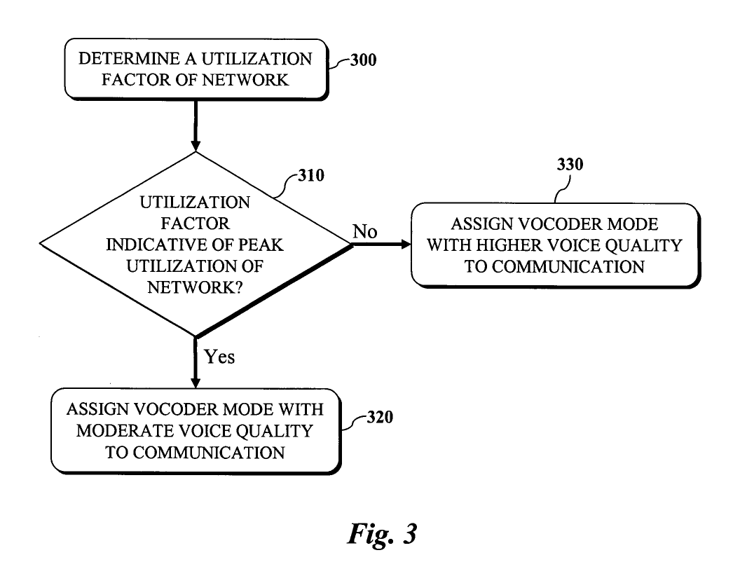

FIG. 3 illustrates an alternative embodiment of a method of the present invention. In step 300, a utilization factor for the network is determined. For example, the network could determine that the network capacity is 75% utilized at that particular time. In step 310, the network determines whether the utilization factor is indicative of a peak utilization of the network. If the determined utilization factor is indicative of peak utilization of the network, in step 320 a vocoder mode with moderate voice quality is used. If the determined utilization factor is not indicative of peak utilization, in step 330 a vocoder mode with higher voice quality is used. In determining whether the utilization factor is indicative of a peak utilization of the network, the present invention is not limited to any particular methodology. For example, the network can use a look-up table to see if the determined utilization factor, e.g., 75%, is within a defined peak utilization range, e.g., 80-100%.

The disclosed embodiments are illustrative of the various ways in which the present invention may be practiced. Other embodiments can be implemented by those skilled in the art without departing from the spirit and scope of the present invention.

What is claimed is:

1. A method for assigning a vocoder mode to a voice communication of a telephone call, comprising the acts of:
determining a time of day; and
assigning a vocoder mode to the voice communication dependent upon the determination of the time of day.

2. The method of claim 1 wherein if the time of day is not associated with a peak period of a utilization of a telecommunications network which transports the telephone call, a first vocoder mode is assigned to the voice communication wherein the first mode provides a voice quality for the communication which is better than a voice quality provided by a second vocoder mode.

3. The method of claim 2 wherein if the time of day is associated with the peak period of the utilization of the telecommunications network, the second vocoder mode is assigned to the voice communication.

4. The method of claim 3 wherein the voice quality provided by the second vocoder mode is less than a quality obtainable by utilizing a full capability of the vocoder.

5. The method of claim 4 wherein a capacity of the network for supporting subscribers is increased as a result of utilizing the second vocoder mode.

6. The method of claim 1 wherein the vocoder is a variable-rate vocoder.

7. The method of claim 1 wherein the vocoder is a multi-rate vocoder.

8. A method for assigning a vocoder mode to a voice communication of a telephone call, comprising the acts of:
determining a utilization factor for a telecommunications network that transports the voice communication of the telephone call; and
assigning a vocoder mode to the voice communication dependent upon the utilization factor.

9. The method of claim 8 wherein if the utilization factor is not indicative of a peak utilization of the telecommunications network, a first vocoder mode is assigned to the voice communication wherein the first mode provides a voice quality for the communication which is better than a voice quality provided by a second vocoder mode.

10. The method of claim 9 wherein if the utilization factor is indicative of the peak utilization of the telecommunications network, the second vocoder mode is assigned to the voice communication.

11. The method of claim 10 wherein the voice quality provided by the second vocoder mode is less than a quality obtainable by utilizing a full capability of the vocoder.

12. The method of claim 11 wherein a capacity of the network for supporting subscribers is increased as a result of utilizing the second vocoder mode.

13. The method of claim 8 wherein the vocoder is a variable-rate vocoder.

14. The method of claim 8 wherein the vocoder is a multi-rate vocoder.

15. A system for increasing capacity in a telecommunications network, comprising:
a variable vocoder, wherein the vocoder includes a first mode and a second mode and wherein the first mode provides a voice quality for a voice communication which is better than a voice quality provided by the second mode;
and further wherein if a utilization factor of the network is not indicative of a peak utilization the first mode is assigned to the voice communication and wherein if the utilization factor is indicative of the peak utilization the second mode is assigned to the voice communication.

16. The system of claim 15 wherein the voice quality provided by the second vocoder mode is less than a quality obtainable by utilizing a full capability of the vocoder.

17. The system of claim 15 wherein the vocoder is a variable-rate vocoder.

18. The system of claim 15 wherein the vocoder is a multi-rate vocoder.

19. A system for increasing capacity in a telecommunications network, comprising:
a variable vocoder, wherein the vocoder includes a first mode and a second mode and wherein the first mode provides a voice quality for a voice communication which is better than a voice quality provided by the second mode;
and further wherein the first mode is assigned to the voice communication during a first time of day that is not associated with a peak utilization of the network and wherein the second mode is assigned to the voice communication during a second time of day that is associated with the peak utilization of the network.

20. The system of claim 19 wherein the voice quality provided by the second vocoder mode is less than a quality obtainable by utilizing a full capability of the vocoder.

21. The system of claim 19 wherein the vocoder is a variable-rate vocoder.

22. The system of claim 19 wherein the vocoder is a multi-rate vocoder.

23. A method for increasing capacity of a network comprising the acts of encoding and decoding a voice communication received from a mobile phone at a rate which is a lesser rate than a maximum rate of a vocoder and wherein a voice quality of the decoded voice communication is a lesser quality than a quality that is achievable by the vocoder by utilizing a higher usable rate of the vocoder.

24. The method of claim 23 wherein the acts of encoding and decoding the voice communication received from the mobile phone at a rate which is a lesser rate than a maximum rate of a vocoder are performed dependent on a designated time of day.

25. The method of claim 23 wherein the acts of encoding and decoding the voice communication received from the mobile phone at a rate which is a lesser rate than a maximum rate of a vocoder are performed dependent on a utilization rate of the network.
